(19) United States
(12) Patent Application Publication
(10) Pub. No.: US 2012/0073769 A1
(43) Pub. Date: Mar. 29, 2012

(54) SUNSHADE FOR VEHICLES

(75) Inventor: Gregory E. Curfman, Jackson, MI (US)

(73) Assignee: UFP Technologies, Inc., Georgetown, MA (US)

(21) Appl. No.: 13/247,253

(22) Filed: Sep. 28, 2011

Related U.S. Application Data
(60) Provisional application No. 61/387,700, filed on Sep. 29, 2010.

(51) Int. Cl. B60J 3/00; B27N 3/18

(52) U.S. Cl. 160/370.21; 264/257; 156/243

(57) ABSTRACT

The present invention related to composited articles for a sunshade and methods for producing the composite articles. The composite article comprises a reinforcing substrate layer including a fiber phase and a polymer phase; and a cover stock layer. The fiber phase may be a discrete phase or a continuous phase and includes one or more natural fiber. The concentration of natural fibers is about 60 weight percent or more, based on the total weight of the reinforcing substrate layer. The polymer phase has a glass transition temperature of about 100° C. or more. The concentration of the polymer phase should be sufficiently high so that it forms a continuous phase. For example, the concentration of the polymer phase may be about 10 weight percent or more, based on the total weight of the reinforcing substrate layer. The reinforcing substrate layer may have a thickness of about 4 mm or less.

### CLAIM OF PRIORITY

The present application claims the benefit of priority of U.S. Provisional Application No. 61/387,700 filed on Sep. 29, 2010, the contents of which are incorporated by reference in its entirety.

### FIELD OF THE INVENTION

The present invention relates to sunshades for vehicles, novel substrates that provide rigidity to the sunshade at high use temperatures, and novel processes for forming sunshades.

### BACKGROUND OF THE INVENTION

Sunshades are generally known in the art for blocking or filtering light passing through an opening in a roof of a vehicle. The sunshade is generally disposed within a pair of guides and is movable between an open position where the opening is exposed and light is allowed to pass through, and a closed position in which the sunshade covers the opening for blocking or filtering the light coming through. The sunshade should have a generally good appearance on the show surface facing the interior of the vehicle.

The sunshade should maintain its general shape so that the sunshade does not sag, does not slip out of a guide, or does not greatly alter the force required to open or close the sunshade. Various methods have been taught by the prior art to stiffen the sunshade. For example, Kloock et al (U.S. Patent Application Publication No. 2010/0026055, published Feb. 4, 2010, incorporated herein by reference in its entirety), teaches sunshades having a substrate layer that is composed of a glass filled polyolefin (such as glass filled polypropylene). Others have used one or more reinforcing members, such as a metal rod, embedded in, or attached to a substrate layer. Such approaches to reinforcing the sunshade add to the processing complexity, weight, and/or cost of the sunshade. Examples of such sunshades include an aesthetic layer, a scrim layer, a substrate layer between the aesthetic layer and the scrim layer, one or more backing layers, and typically one or more adhesive layers. Additionally, adhesives for attaching two adjoining layers, and/or chemical treatments for improving the adhesion between a polymer in the substrate layer and a reinforcing fiber or a reinforcing member are often required.

It is desirable for the sunshade to have low weight so that the weight of a vehicle can be reduced (and its fuel efficiency can be increased). It is also desirable for the sunshade to include renewable materials. It is also desirable for the sunshade to include fewer layers, so that the manufacturing can be simplified and/or the cost reduced.

There is a need for sunshades having reduced weight, for sunshades that include renewable materials, for sunshades that can be manufactured with fewer steps, or any combination thereof. Additionally there is a need for sunshades that can be used at higher temperatures, retain their shape for longer times, are thinner, or any combination thereof.

### SUMMARY OF THE INVENTION

One aspect of the invention is an article for a sunshade comprising a reinforcing substrate layer including a fiber phase and a continuous polymer phase, wherein the fiber phase is a discrete phase or a continuous phase and includes one or more natural fibers, the concentration of natural fibers is about 60 weight percent or more, based on the total weight of the reinforcing substrate layer, the polymer phase has a glass transition temperature of about 100° C. or more, the concentration of the polymer phase is about 10 weight percent or more, based on the total weight of the reinforcing substrate layer, and the reinforcing substrate layer has a thickness of about 4 mm or less; and a cover stock layer attached to a first surface of the reinforcing substrate layer, wherein the cover stock layer has a class A surface; so that the area density of the composite article is about 5,000 g/m² or less (preferably about 2,500 g/m² or less), and the volume density of the composite article is about 1.5 g/cm³ or less.

Another aspect of the invention is a process for preparing a composite article, such as an article described herein (e.g., a sunshade), including the steps of impregnating a mat with a polymer solution, wherein the mat includes one or more natural fibers and has open spaces, and the polymer solution includes one or more polymers and a sufficient amount of water so that the polymer solution can flow into the open spaces of the mat to form an impregnated mat; partially drying the impregnated mat to form a dried impregnated mat, wherein the dried impregnated mat is sufficiently dried to reduce the water concentration and/or partially cure the polymer so that the dried impregnated mat can be handled as a solid and so that the polymer does not flow out of the mat, wherein the concentration of water in the dried impregnated mat is about 10 wt. % or more, based on the total weight of the water and the one or more polymers, so that the polymer can be cured to a higher level of cure, so that the polymer can be cured at lower temperatures, or both; curing the polymer in a mold under pressure and at a sufficiently high curing time and curing temperature so that the polymer has a glass transition temperature greater than about 100° C., and the impregnated mat becomes a reinforcing substrate, so that a light weight composite article is formed.

Another aspect of the invention is directed at a vehicle having a sunshade, wherein the sunshade includes a composite article described herein.

### BRIEF DESCRIPTION OF THE FIGURES

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1 is an illustrative drawing of a vehicle including a sunshade.

FIG. 2 is a drawing of an illustrative composite article.

FIG. 3 is a drawing of an illustrative cross-section.

### DETAILED DESCRIPTION OF THE PRESENT INVENTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The sunshades of the present invention employ novel combinations of materials and/or multi-layered structures that result in sunshades having properties previously unattainable. The sunshades advantageously may have one or any combination of the following features: the sunshade and/or the reinforcing layer of the sunshade may be generally light weight (e.g., having a generally low volume density, a generally low area density, or both; such as a volume density and/or area density lower than that of a reinforcing layer that consists essentially of glass reinforced polypropylene or glass reinforced polyurethane, or a sunshade made therefrom); the sunshade may include one or more natural and/or renewable materials; the sunshade may have a generally high temperature heat resistance (e.g., about 100° C. or more, or about 120° C. or more); the sunshade may free of any adhesive layer, the sunshade may be free of any scrim layer, the sunshade may be free of scrim colorant; the sunshade may include a thermoset material (preferably a thermoset material that is a natural and/or renewable material).

The sunshade preferably is configured to move between an open position in which light can enter the vehicle, and a closed position in which the sunshade substantially or completely covers a window (e.g., a window in the roof of the vehicle) so that light is substantially prevented from entering the vehicle through the window. The sunshade may open and close by sliding between two or more guides, such as a first guide and second guide. The second guide is spaced from the first guide and is preferably generally parallel to the first guide.

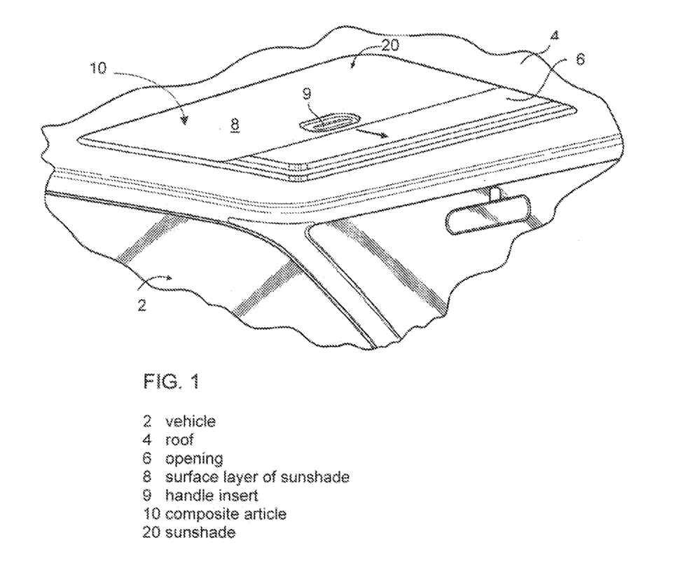

An illustrative vehicle 2 including a sunshade 20 is shown in FIG. 1, as viewed from the interior of the vehicle. The sunshade 20 is capable of moving between an open position that allows light to enter the vehicle 2 through an opening 6 and a closed position that substantially prevents light from entering the vehicle 2 through the opening 6. The sunshade 20 may be include a composite article (i.e., a panel portion) 10, such as a composite article described herein. As illustrated in FIG. 1, the opening 6 may be in the roof 4 of a vehicle. The sunshade 20 may include a means for opening the sunshade, such as a handle insert 9. As illustrated in FIG. 1, the sunshade 20 will have a surface 8 that faces the interior of the vehicle 2.

It will be appreciated that the sunshade may include one or more features or components known to those generally skilled in the art that may assist in the movement of the sunshade, improve the appearance of the sunshade, assist in the positioning of the sunshade, and the like. A feature that assists in the movement of the sunshade, may be employed to open the sunshade manually, electromechanically, or both. Without limitation, the sunshade may include a handle, a handle insert, an opening for a handle insert, a trim, or any combination thereof.

### Composite Article

The sunshade preferably includes or consists essentially of a composite article (i.e., a panel portion). The panel portion may have a first surface faces the interior of the vehicle. As such, the first surface is generally a show surface. The first surface preferably has generally good aesthetics, and preferably is a class A surface. The panel portion may have a second surface that faces away from the interior of the vehicle. The second surface may be generally hidden from view from within the interior of the vehicle. The second surface may be visible from the exterior of the vehicle, particularly when the sunshade is in a closed position. As such, it may be desirable for the second surface to have a predetermined color so that the sunshade is aesthetically pleasing from the exterior of the vehicle.

The panel portion preferably is light weight so that the weight of the vehicle is low, so that the vehicle is fuel efficient, or both. A light weight panel portion preferably is a composite article including one or more reinforcing substrate layers and an aesthetic layer, such as a cover stock layer. The reinforcing substrate layer preferably provides stiffness and/or rigidity to the composite article. The aesthetic layer preferably provides a show surface to the composite article. As discussed herein, the reinforcing substrate layer preferably provides stiffness and/or rigidity to the composite article, the sunshade, or both, even at elevated temperatures, such as at 100° C., or at 120° C.

The composite article may include a scrim layer. The scrim layer, if employed may be the layer facing away from the interior of the vehicle (i.e., the second surface visible from the outside of the vehicle through the opening when the sunshade is closed). As such, the reinforcing substrate layer may be partially or even entirely interposed between the cover stock layer and the scrim layer. Any art known scrim layer may be employed. A scrim layer may be employed to provide a predetermined color to the second surface of the article, to protect the reinforcing substrate layer from light (e.g., visible, infrared, and/or ultraviolet light), to protect the reinforcing substrate layer from heat, or any combination thereof.

The composite article may include one or more backing layers and or one or more adhesive layers. For example, the composite article may employ a back layer to separate a surface layer from the reinforcing substrate layer. The backing layer preferably is a barrier so that a surface layer does not become contaminated by another layer such as the reinforcing substrate layer. A backing layer may be interposed between and optionally adhered to the reinforcing substrate layer and the aesthetic layer. A backing layer may be interposed between and optionally adhered to the reinforcing substrate layer and the scrim layer. An adhesive layer may be employed to adhere a surface layer to another layer. By way of example, an adhesive layer may be employed to adhesively join a reinforcing layer to an aesthetic layer, a backing layer, or a scrim layer; or to adhesively join a backing layer to an aesthetic layer or a scrim layer. A backing layer, if employed, may additionally function to adhesively join two or more layers.

The composite article preferably is free of any backing layer and/or adhesive layer interposed between the aesthetic layer and the reinforcing substrate layer. By way of example, the aesthetic layer may be directly joined to the reinforcing substrate layer with, or without an adhesive.

If a scrim layer is employed, the composite article preferably is free of any backing layer and/or adhesive layer interposed between the scrim layer and the reinforcing substrate layer. By way of example, the scrim layer may be directly joined to the reinforcing substrate layer with, or without an adhesive. Preferably the composite article is free of a scrim layer. For example, the second surface of the composite article (i.e., the surface facing the exterior of the vehicle) maybe a surface of the reinforcing substrate layer.

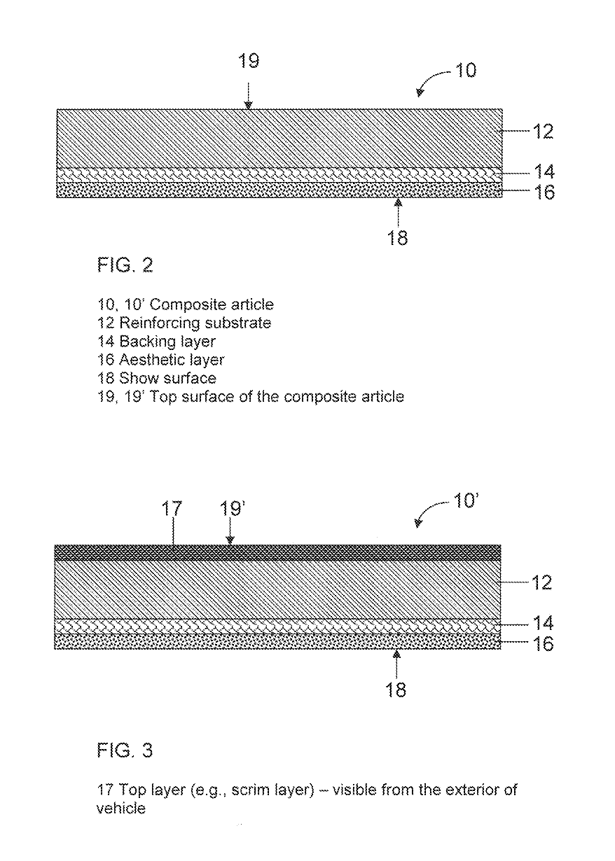

FIG. 2 is an illustrative cross-section of a composite article 10 including an aesthetic layer 16 and a reinforcing substrate layer 12. A backing layer 14 is interposed between the reinforcing substrate layer 12 and the aesthetic layer 16. It will be appreciated from the teachings herein that the backing layer 14 may be omitted, and/or an adhesive layer (not shown) may be employed to join the backing layer 14 to the reinforcing substrate layer 12 or to the aesthetic layer 16 or to join the reinforcing substrate layer 12 to the aesthetic layer 16. The composite article has two opposing primary surfaces, the show surface 18 (e.g., the surface that faces the interior of the vehicle) and the top surface 19 (e.g., the surface that faces the exterior of the vehicle). It will be appreciated that the two primary surfaces 18, 19 are generally the largest surfaces of the composite article, and may be the only exposed surface of the composite article. As illustrated in FIG. 2, the top surface of the composite article 19 may be a surface of the reinforcing substrate layer.

FIG. 3 is a cross-section of an illustrative composite article 10′ that includes a scrim layer 17. The top surface of the composite article (i.e., the second surface) 19′ may be a surface of the scrim layer 17. As illustrated in FIG. 3, the scrim layer 17 may be directly joined to the reinforcing substrate layer 12. However, as discussed herein, a backing layer and/or one or more adhesive layers may be interposed between the scrim layer 17 and the reinforcing substrate layer 12.

### Reinforcing Substrate Layer

The reinforcing substrate layer provides stiffness and/or rigidity to the composite article. Preferably the reinforcing substrate layer is light weight so that the composite article is generally light weight. As such, the reinforcing substrate layer preferably is made of materials which together produce a layer that is both rigid and light weight. It will be appreciated that the reinforcing substrate layer should maintain generally high stiffness and/or rigidity, over the range of temperatures to which a vehicle roof may be exposed.

The reinforcing substrate layer includes a polymer phase and a fiber phase. The polymer phase is preferably a continuous phase. The fiber phase may be a discrete phase dispersed in the polymer phase. The fibers may be uniformly dispersed in the polymer phase, or the concentration of fibers may vary in two or more different regions of the reinforcing substrate layer. Preferably, the fibers are uniformly dispersed in the polymer phase. The fibers may have any orientation in the polymer phase. For example, the fibers may have a generally random orientation, may be generally axially aligned, may be generally aligned in a plane, or any combination thereof. The concentration of the fibers and the alignment of the fibers, if any, should be sufficient so the at fibers reinforce the polymer phase. As such, the reinforcing substrate layer including the fiber phase may have a relatively high heat distortion temperature, a relatively high elastic modulus, a relatively high flexural modulus, or any combination thereof, compared with the material of the polymer phase without the fibers.

Preferably, the reinforcing substrate layer is solid. For example, the reinforcing substrate layer may be generally non-porous. If pores are present, the concentration of voids preferably is sufficiently low so that the substrate is sufficiently rigid to support the weight of the sunshade. The concentration of voids, if present, may be about 25 volume percent or less, preferably about 10 volume percent or less, more preferably about 2 volume percent or less, even more preferably less than 1 volume percent, and most preferably about 0.5 volume percent or less, based on the total volume of the reinforcing substrate layer. It will be appreciated that the concentration of voids may be about 0.0 volume percent, or about 0.1 volume percent or more, based on the total volume of the reinforcing substrate layer.

The rigidity of the reinforcing substrate layer is surprisingly high, thus allowing for a reinforcing substrate layer that is generally low. The thickness of the reinforcing substrate layer preferably is about 4.0 mm or less, more preferably about 3.75 mm or less, even more preferably about 3.5 mm or less, even more preferably about 3.25 mm or less, and most preferably about 3.0 mm or less. The reinforcing substrate layer preferably has a thickness of about 0.7 mm or more, more preferably about 1.5 mm or more, and most preferably about 2.0 mm or more.

The materials of the reinforcing substrate layer are selected so that the reinforcing substrate layer has a surprisingly low volume density, area density, or both. The volume density of the substrate layer is preferably about 1.50 g/cm³ or less, more preferably about 1.30 g/cm³ or less, even more preferably about 1.15 g/cm³ or less, and most preferably about 1.10 g/cm³ or less. The volume density of the reinforcing substrate layer is preferably about 0.7 g/cm³ or more, more preferably about 0.8 g/cm³ or more, even more preferably about 0.86 g/cm³ or more, and most preferably about 0.93 g/cm³ or more. The reinforcing substrate layer preferably has an area density of about 2400 g/m² or less, more preferably about 2000 g/m² or less, even more preferably about 1750 g/m² or less, even more preferably about 1650 g/m² or less, even more preferably about 1550 g/m² or less, and most preferably about 1450 g/m² or less. The reinforcing substrate layer preferably has an area density of about 400 g/m² or more.

The reinforcing substrate layer preferably includes a sufficient concentration of natural fibers so that the layer is rigid. The concentration of the natural fibers in the reinforcing substrate layer may be about 40 weight percent or more, more preferably about 50 weight percent or more, even more preferably about 60 weight percent or more, and most preferably about 65 weight percent or more. The concentration of the natural fibers in the reinforcing substrate layers preferably is about 90 weight percent or less. The concentration of the polymer phase in the reinforcing substrate layer may be about 60 weight percent or less, preferably about 50 weight percent or less, even more preferably about 35 weight percent or less, and most preferably about 30 weight percent or less. The concentration of the polymer phase in the reinforcing substrate layer preferably is about 10 weight percent or more, more preferably about 20 weight percent or more, even more preferably about 20 weight percent or more, and most preferably about 25 weight percent or more, based on the total weight of the reinforcing substrate layer. The reinforcing substrate layer preferably consists essentially of, or even entirely of the polymeric phase and the natural fibers. Preferably the total concentration of the polymeric fibers and the natural fibers is about 70 weight percent or more, more preferably about 85 weight percent or more, even more preferably about 95 weight percent or more, and most preferably about 98 weight percent or more.

The fibers preferably are generally strong and light weight. For example, natural fibers may have both a desirably high tensile strength and a desirably high specific gravity so that the weight of the substrate can be reduced while maintaining a high stiffness:

The fibers may have a specific gravity of about 2.0 g/cm³ or less, preferably about 1.9 g/cm³ or less, more preferably about 1.8 g/cm³ or less, even more preferably about 1.7 g/cm³ or less, even more preferably about 1.6 g/cm³ or less, and most preferably about 1.5 g/cm³ or less. The fibers typically have a specific gravity of about 0.7 g/cm³ or more.

Natural fibers that may be employed in the substrate layer include animal fibers and vegetable fibers. Examples of vegetable fibers include seed fibers, leaf fibers, bast fibers (i.e., skin fibers), fruit fibers, and stalk fibers. Seed fibers include fibers from seeds and seed cases, such as cotton and kapok. Leaf fibers include fibers collected from leaves, such as agave, banana, fique, and sisal. Bast fibers include fibers collected from the bast or skin around the stem of a plant, such as flax, hemp, jute, kenaf, ramie, rattan, and vine fibers. Fruit fibers include fibers collected from the fruit of a plant, such as coconut fibers (i.e., coir fibers). Stalk fibers include fibers collected from the stalk of a plant such as bamboo stalks, barley stalks, straws of wheat, rice stalks, grass stalks, and tree wood. Preferred fibers include bast fibers. More preferred fibers include flax, hemp, flax, jute, ramie, rattan, or combinations thereof.

The natural fibers preferably are sufficiently hygroscopic so that they can provide water for curing the polymer, absorb residual water from the cured polymer (such as after a step of curing a polymer solution at a high temperature), or both. Hygroscopic fibers may be characterized as having a generally high water absorption, measured as percent increase in weight, after dry fibers are placed in water at about 25° C. for about 2 hours. The water absorption of the fibers preferably is about 5 weight percent or more, more preferably about 10 weight percent or more, even more preferably about 20 weight percent or more, and most preferably about 38 weight percent or more.

The natural fibers are preferably sufficiently long so that they provide reinforcement to the substrate layer. The natural fibers of the reinforcing substrate layer preferably includes or consists essentially of fibers that are sufficiently long so that they are entangled with one, two, three, four, or more other fibers. The weight average length of the natural fibers preferably is about 2 mm or more, more preferably about 10 mm or more, even more preferably about 15 mm or more, and most preferably about 25 mm or more. In particularly preferred aspects of the invention, the fibers may be very long, such as fibers having a length of about 53 mm or more, about 60 mm or more, about 75 mm or more, or about 100 mm or more. It will be appreciated that the fibers may be essentially continuous fibers, such as a woven fiber.

The natural fibers preferably are provided in a form suitable for combining with the polymer solution. For example, the natural fibers may be provided as a mass of fibers having a sufficient amount of pores so that the polymer solution can wet the surfaces of the fibers. The natural fibers may be provided as individual fibers, as groups of fibers, as a nonwoven material, as a woven material, or any combination thereof. The natural fibers may optionally be provided with other fibers that are not natural fibers, such as in a blend, a weave, a warp, or any combination thereof. Preferably the natural fibers are provided as a material without other fibers. More preferably, the natural fibers are provided as one or more sheets of fibers, woven, nonwoven, matted, or otherwise.

The fiber phase may be generally free of glass fibers and/or other generally dense fibers having a density of about 2.0 g/cm³ or more. If present, the concentration of dense fibers in the reinforcing substrate layer, in the composite sheet, or both, preferably is about 20 wt. % or less, about 10 wt. % or less, about 5 wt. % or less, or about 1 wt. % or less, based on the total weight of the fibers in the composite sheet and/or based on the total weight of the composite sheet.

### Polymer Phase

The polymer phase of the reinforcing substrate includes one or more polymers that may function as a matrix for the fibers. The polymer phase preferably includes or consists essentially of one or more high temperature polymers. The one or more high temperature polymer preferably is capable of supporting a load at a high temperature, such as at 100° C., or at 120° C. The high temperature polymer may be characterized by a first or second order transition (such as a peak melting temperature, a glass transition temperature, or both) that is about 100° C. or more, preferably about 110° C. or more, more preferably about 120° C. or more, even more preferably about 125° C. or more, and most preferably about 130° C. or more.

The polymer may include a thermosetting polymer that initially is a liquid at room temperature, so that it can easily flow into the spaces between the fibers, and upon cross linking or other thermosetting reaction the thermosetting polymer may develop a high glass transition temperature so that the substrate can be used in high temperature applications. As such, a particularly preferred substrate includes a polymer having a glass transition temperature of about 120° C. or more.

Preferred polymers for use in the polymer phase are polymers that are moisture curable. Moisture curable polymers either require water for curing, or have a cure rate in the presence of water that is substantially greater than the cure rate in a moisture free environment. For example, the ratio of the cure rate of the polymer in the presence of water (e.g., at a water concentration of about 5 weight % or more) to the cure rate of the polymer without water may be about 1.5 or more, about 2.0 or more, or about 3.0 or more.

Preferably the polymer phase includes, or consists essentially of one or more polymers having an ethylinically unsaturated acid monomer, one or more polymers including a styrene, or any combination thereof. The polymer having an ethylinically unsaturated acid monomer is preferably selected from an ethylinically unsaturated monocarboxylic acid, an ethylinically unsaturated dicarboxylic acid, an ethylinically unsaturated dicarboxylic anhydride, and any combination thereof. The polymer having an ethylinically unsaturated acid monomer may be a homopolymer, a copolymer, or both, and preferably includes, or consists essentially of a copolymer. The concentration of the ethylinically unsaturated acid monomer preferably is about 2 weight % or more, more preferably about 4 weight % or more, and most preferably about 5 weight % or more, based on the total weight of the polymer phase. A particularly preferred ethylinically unsaturated acid monomer is acrylic acid. For example, the polymer phase may include an acrylic acid copolymer. If employed, the acrylic acid copolymer preferably includes, or consists essentially of acrylic acid and styrene. The total concentration of acrylic acid and styrene in the acrylic acid containing copolymer preferably is about 50 weight or more, more preferably about 70 weight percent or more, more preferably about 90 weight percent or more, and most preferably about weight percent or more. The acrylic acid copolymer may contain maleic anhydride in addition to, or in place of the styrene. The acrylic acid copolymer may include one or more acrylate monomers in addition to or in place of the styrene. The copolymer may be a random copolymer, a block copolymer, an alternating copolymer, have an intermediate monomer arrangement thereof, or any combination thereof. Block copolymers may independently have one, two, three, four or more blocks of each monomer. The styrene containing polymer, if employed, may be a homopolymer or a copolymer. A particularly preferred styrene containing polymer is a copolymer including about 5 weight percent or more styrene. The styrene containing polymer may be Preferred styrene containing polymers include copolymers having or consisting essentially of styrene and one or more acrylates. The total concentration of styrene and acrylate in the styrene containing copolymer preferably is about 40 weight percent or more, more preferably about 70 weight percent or more, even more preferably about 80 weight percent or more, and even more preferably about 90 weight percent or more, and most preferably about 95 weight percent or more, based on the total weight of the styrene containing copolymer. The styrene containing copolymer may be a random copolymer, a block copolymer, an alternating copolymer, have an intermediate monomer arrangement thereof, or any combination thereof. Block copolymers may independently have one, two, three, four or more blocks of each monomer. The styrene containing copolymer includes one or more additional monomers or may be modified so that it can react with a cross-linking agent. The styrene containing copolymer may react with any cross-linking agent having, such as an amine cross-linking agent, a polyol cross-linking agent, and the like. Preferably, the styrene containing copolymer is modified with a carboxylic acid, or a polycarboxylic acid.

The polymer phase preferably is present in the reinforcing substrate layer at a sufficient concentration so that the polymer phase is a continuous phase. The concentration of the polymer phase preferably is about 10 weight percent or more, more preferably about 15 weight percent or more, even more preferably about 20 weight percent or more, and most preferably about 25 weight percent or more, based on the total weight of the reinforcing substrate layer. It will be appreciated that since the reinforcing substrate layer also includes a fiber phase, the concentration of the polymer phase will be less than 100%. The concentration of the polymer phase may be about 90 weight percent or less, preferably about 80 weight percent or less, more preferably about 70 weight percent or less, even more preferably about 60 weight percent or less, and most preferably about 50 weight percent or less, based on the total weight of the reinforcing substrate layer.

The polymer phase and the fiber phase may be a large portion of the reinforcing substrate layer. For example, the total concentration of the polymer phase and the fiber phase may be about 60 weight percent or more, preferably about 80 weight percent or more, more preferably about 90 weight percent or more, even more preferably about 97 weight percent or more, and most preferably about 99.5 weight percent or more, based on the total weight of the reinforcing substrate layer. It will be appreciated that the reinforcing substrate layer may consist essentially of the fiber phase and the polymer phase. As such the total concentration of the polymer phase and the fiber phase may be about 100 weight percent or less, or about 99.6 weight percent or less.

The polymer phase preferably wets and/or adheres to the fibers. When a composite including fibers and a polymer phase that does not wet or adhere to the fiber is fractured, the fibers may pull out of the polymer phase, the polymer phase may have generally low plastic deformation near the fibers, or both. Preferably the polymer phase wets and/or adheres to the fibers sufficiently so that upon fracturing, the fracture surface is generally free of fibers that have pulled out of the polymer phase, the polymer phase near the fibers have generally low evidence of plastic deformation (e.g., as determined by scanning electron microscopy of a fracture sample, such as a sample fractured at about 23° C. using ASTM D256), or both.

In the composite article, some, or essentially all of a polymer in the polymer phase of the reinforcing substrate layer may be cured and/or cross-linked. Preferably, a sufficient amount of polymer is cured and/or cross-linked so that a polymer network is created. As described herein, the polymer may be cured using one or more curatives, one or more, cure accelerators, or both. The reinforcing substrate layer may include residual (i.e., unreacted) curative, or may be substantially free of residual curative. The reinforcing layer may include residual cure accelerator, or may be substantially free of residual cure accelerator.

The reinforcing substrate layers may include one or more additives known to those of ordinary skill in the art. Preferred additives include one or more stabilizers, one or more flow modifiers, one or more process aids, one or more surfactants, one or more emulsifiers, one or more defoamers, or any combination thereof. Without limitation, the stabilizer may include a heat stabilizer, a light stabilizer, an antioxidant, an antiozonant, a flame retardant, or any combination thereof. Additional ingredients may be added to accelerate or retard a curing or cross-linking reaction at storage temperatures (i.e., before curing), at curing temperatures, or both.

The reinforcing substrate may include one or more adhesion promoters for improving the adhesion between fibers and the polymer phase. Any adhesion promoter known in the art for adhering fibers and polymers may be employed. Preferred adhesion promoters include silanes and coupling agents. Without limitation, examples of adhesion promoters include those described by J. L. O'Dell, “Natural Fibers in Resin Transfer Molded Composites”, The Fourth International Conference on Woodfiber-Plastic Composites, The Forest Products Society: Proceedings No. 7277, pages 280-285, 1997, incorporated herein by reference in its entirety. The reinforcing substrate may employ a fiber and a polymer phase having good adhesion without the use of an adhesion promoter. In preferred aspects of the invention, the reinforcing substrate and/or the composite article is substantially free of fibers that have been treated with a silane and/or a coupling agent for promoting adhesion between the polymer and the fibers. As such, preferred reinforcing substrates may be substantially free of, or entirely free of silanes and/or coupling agents.

The reinforcing substrate layer may include one or more colorants, one or more pigments, one or more dyes, or any combination thereof. In a particularly preferred embodiment of the invention the reinforcing substrate layer includes a sufficient quantity of colorant, pigment, and/or dye so that the reinforcing substrate layer has a predetermined color. For example, the reinforcing substrate layer may include one or more colorants, pigments, or dyes other than carbon black. As such, the reinforcing substrate layer may advantageously be used for producing a sun shade that is substantially free of a layer on the surface that faces the exterior of the vehicle. For example, the sun shade may be free of a scrim layer covering the top surface of the reinforcing substrate layer. The colorant, pigment and/or dye may be included in the natural fibers, in the polymer phase, or both. Preferably the colorant, pigment and/or dye is included at least in the polymer phase. If a colorant, pigment and/or dye is included in the reinforcing substrate layer, the substrate layer preferably includes one or more light stabilizers, such as one or more UV light stabilizers.

The reinforcing substrate layer may be prepared using a process that includes a step of providing the one or more polymers, a step of providing the fibers and a step of wetting or impregnating the fibers with at least the polymer.

The one or more polymers may be provided as a solid polymer, a polymer melt, a polymer solution, or any combination thereof. Preferably the one or more polymers are provided as a polymer solution including one or more liquids. As used herein, the term polymer solution includes polymers dissolved in one or more solvents and polymers in an emulsion. In a particularly preferred aspect of the invention, the one or more polymers are provided as an emulsion in water. For example, the concentration of the one or more polymers in the emulsion, the solids content of the emulsion, or both, is preferably about 15 weight percent or more, more preferably about 25 weight percent or more, and most preferably about 35 weight percent or more, based on the total weight of the emulsion. The solids concentration of the polymers in the emulsion, the solids content of the emulsion, or both, preferably is about 80 weight percent or less, more preferably about 70 weight percent or less, and most preferably about 60 weight percent or less. The water concentration of the emulsion may be about 20 weight percent or more, more preferably about 30 weight percent or more, and most preferably about 40 weight percent or more. The concentration of water in the emulsion preferably is about 85 weight percent or less, more preferably about 75 weight percent or less, and most preferably about 65 weight percent or less. The emulsion may include an emulsifier, a defoamer, a surfactant, or any combination thereof. The emulsion preferably includes one or more curatives, one or more cure accelerators, one or more cure retarders, or any combination thereof. If the emulsion includes a curative, the curative preferably does not cause the polymer to significantly cross-link during storage. For example, the curative may be physically isolated from the polymer, the curative may be capped or otherwise deactivated, the curative may require an initiator and/or an accelerator that is physically isolated from the polymer, the curative or both, the cure rate may be generally low at storage temperatures (e.g., at about 25° C.), or any combination thereof. Preferably the polymer solution is a 1 component, shelf stable solution. A particularly preferred curative is a polyol.

The polymer solution preferably is prepared before contacting the polymer with the fibers. Suitable polymer solutions are commercially available for example as ACRODUR® from BASF Company, Ludwigshafen, Germany. Preferred grades include ACRODUR® DS 3515 characterized by a solids content of about 50 weight percent, a pH of about 3.5 and a viscosity of about 150-300 mPas; ACRODUR® DS 3530 characterized by solids content of about 50 weight percent, a pH of about 3.5 and a viscosity of about 150 to about 300 mPas; ACRODUR® DS 3558 characterized by a solids content of about 50 weight percent, a pH of about 3.5 and a viscosity of about 300 to about 1500 mPas; and ACRODUR® 950L characterized by a solids content of about 50 weight percent, a pH of about 3.5 and a viscosity of about 900 to about 2500 mPas.

The process for preparing the composite article may includes a step of impregnating the fibers with the natural fibers. For example, a mat of natural fibers may be impregnated by the polymer solution. Preferably the natural fibers (e.g., the mat of natural fibers includes a sufficient amount of open spaces, and the polymer solution includes a sufficient amount of water so that the polymer solution can flow into the open spaces (e.g. to form an impregnated mat).

The process for preparing the composite article may include a step of partially drying the impregnated natural fibers (e.g. the impregnated mat) to form partially dried impregnated natural fibers. Drying the impregnated natural fibers may reduce the water concentration of the impregnated fibers, partially cure the polymer, or both. The partially dried impregnated natural fibers (e.g., the partially dried impregnated mat) preferably is sufficiently dried to reduce the water concentration and/or partially cure the polymer so that it can be handled as a solid, so that the polymer does not flow out of the fibers, or both.

The concentration of water in the partially dried impregnated fibers is preferably about 4 weight percent or more, more preferably about 7 weight percent or more, even more preferably about 10 weight percent or more, and most preferably about 15 weight percent or more, based on the total weight of the water and the one or more polymers. The concentration of water in the partially dried impregnated fibers is preferably about 30 weight percent or less, more preferably about 25 weight percent or less, even more preferably about 23 weight percent or less, and most preferably about 13 weight percent or less, based on the total weight of the water and the one or more polymers. The concentration of water in the partially dried impregnated fibers preferably is sufficiently high so that the polymer can be cured to a higher level of cure, so that the polymer can be cured at lower temperatures, or both.

The process for preparing the composite article may include a step of curing the polymer in a mold under pressure and at a sufficiently high curing time and curing temperature so that the polymer phase achieves a glass transition temperature of about 100° C. or more, preferably about 110° C. or more, even more preferably about 120° C. or more, and most preferably about 130° C. or more. As the polymer phase cures, the impregnated fibers become a reinforcing substrate. The mold preferably is a vented mold so that water can be removed. The curing temperature preferably is about 130° C. or more, more preferably about 150° C. or more, even more preferably about 170° C. or more, even more preferably about 190° C. or more, and most preferably about 205° C. or more.

The difference in the concentration of water in the impregnated fibers before the high temperature curing step in the mold and the concentration of water in the impregnated fibers after the high temperature curing step in the mold, is preferably about 7 weight percent or more, more preferably about 10 weight percent or more, even more preferably about 12 weight percent or more, and most preferably about 15 weight percent or more, based on the total weight of the water and the one or more polymers of the polymer solution.

The process may include one or more steps of shaping the impregnated fibers, the partially dried impregnated fibers, or both. Preferably, the process includes a step of shaping the partially dried impregnated fibers in the mold during the high temperature curing step.

The process may include a step of applying an aesthetic layer, such as a cover stock layer having one or more class A surfaces into the mold so that the composite article has a class A surface. The aesthetic layer may be attached to a backing layer, so that the aesthetic layer is isolated from the impregnated mat. If employed, the backing layer may be adhesively joined to or otherwise attached to the reinforcing substrate during the molding step. Preferably, the composite article is free of a backing layer between the reinforcing substrate layer and the aesthetic layer. Preferably, the aesthetic layer and/or the reinforcing substrate layer (e.g., during the temperature curing step) to one or more other layers without the need for an adhesive layer. For example, the process may be free of a step of applying an adhesive to an aesthetic layer or to a reinforcing substrate (e.g., for attaching the aesthetic layer to the reinforcing substrate). As another example, the process may be free of a step of applying an adhesive to a backing layer or to a reinforcing substrate (e.g., for attaching the backing layer to the reinforcing substrate).

The process may include a step of arranging the partially dried impregnated fibers, the aesthetic layer, and any optional layer of the composite article into a stack of layers; placing the stack of layers into a mold; and molding the stack of layers, wherein the molding step includes forming the article in the mold, curing the partially dried impregnated fibers in the mold to form the reinforcing substrate layers, and adhesively joining each pair of adjacent layers in the mold. As such, the process may be a one-step process in that all of the layers are formed and joined in one molding step. Thus, the process may advantageously be free a step of joining two or more layers together after the molding step and/or joining two or more layers together before the molding step. In other words, the process may require few joining steps, or even require no joining steps other than the joining of the layers during the molding step.

Surprisingly, the generally high water concentrations of the partially dried impregnated fibers allows for short molding times, despite the need to remove additional moisture from the composite article during the molding step. For example the molding cycle time may be reduced by about 5% or more, more preferably by about 10% or more, and most preferably by about 15% or more compared with an identical process using the same material except the partially dried impregnated fibers are replaced with nearly completely dried impregnated fibers having a water concentration of about 5 weight percent or less, based on the total weight of the water and the polymer.

The selection of materials and the use of the partially dried impregnated natural fibers results in materials having reduced weight, improved rigidity, particularly at high temperatures, and more efficient manufacturing process, in that shorter cycle times are attained and that few joining steps are required.

The molding process may be a batch process or a continuous process. In a batch process, the layers may be cut into a suitable length and width for placing in a mold. In a continuous process, one or more of the layers may be continuously fed into a mold.

The composite article may be tested for high temperature performance by forming the composite article into a sunshade having a length of about 500 mm or more and a width of about 300 mm or more, exposing the composite article to 2 cycles of heating the sunshade to 120° C. for 12 hours each and cooling the sunshade to 25° for 12 hours each high temperature performance testing the length and width of the sunshade is preferably within 5 mm, more preferably within 2 mm of their initial values. Additionally the various layers of the sunshade do not delaminate.

The composite article preferably has an area density of about 3,000 g/m² or less, more preferably about 2,600 g/m² or less, even more preferably about 2,200 g/m² or less, and most preferably about 1,900 g/m² or less.

The area density of a material in sheet form is determined by measuring the mass of 1 square meter of the sheet. The area density may be expressed in units of g/m². The volume density of a material is the mass of 1 cm³ of material. The volume density may be expressed in units of g/cm³.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A composite article for a sunshade comprising:
i) a reinforcing substrate layer including a fiber phase and a polymer phase, wherein
the fiber phase is a discrete phase or a continuous phase and includes one or more natural fibers,
the natural fibers are present at a concentration of about 60 weight percent or more, based on the total weight of the reinforcing substrate layer,
the polymer phase has a glass transition temperature of about 100° C. or more,
the polymer phase is a continuous phase,
the concentration of the polymer phase is about 10 weight percent or more, based on the total weight of the reinforcing substrate layer, and the reinforcing substrate layer has a thickness of about 4 mm or less; and
ii) a cover stock layer attached to a first surface of the reinforcing substrate layer, wherein the cover stock layer has a class A surface;
so that the composite article has an area density of about 5,000 g/m² or less, and the composite article has a volume density of about 1.5 g/cm³ or less.

2. The composite article of claim 1, wherein the polymer phase has a glass transition temperature of about 120° C. or more, the composite article has a flexural modulus of about 60 MPa or more; or both.

3. The composite article of claim 2, wherein the reinforcing substrate layer has an area density of about 2400 g/m² or less.

4. The composite article of claim 3, wherein the reinforcing substrate layer has a volume density of about 1.15 g/cm³ or less; the reinforcing substrate layer is substantially non-porous; the reinforcing substrate layer has a thickness of about 2.5 mm or less; and the area density of the composite article is about 3,000 g/m² or less.

5. The composite article of claim 1, wherein the reinforcing substrate layer has a second surface opposing the first surface, and the reinforcing substrate layer includes a dye, pigment, or other colorant;
so that the second surface of the reinforcing substrate layer has a predetermined color, so that the article is free of any scrim layer attached to the second surface, or both.

6. The composite article of claim 1, wherein the composite article includes a backing layer interposed between the cover stock layer and the reinforcing substrate layer.

7. The composite article of claim 1, wherein the composite article is free of any adhesive interposed between the cover stock layer and the reinforcing substrate layer.

8. The composite article of claim 1, wherein the composite article is substantially free of glass fibers, the composite article is substantially free of any reinforcing members other than the reinforcing substrate layer, and the composite article is substantially free of fibers having a specific gravity greater than about 2.

9. The composite article of claim 1, wherein the article has an initial length and an initial width at about 25° C., and after heating the article to 100° C. for 120 minutes followed by cooling the article to 25° C., the article has a final length that is within 5% of initial length and a final width that is within 5% of the initial width.

10. The composite article of claim 1, wherein the polymer phase includes one or more polymers having an ethylenically unsaturated monocarboxylic acid, a dicarboxylic acid, a dicarboxylic anhydride, or any combination thereof.

11. The composite article of claim 1, wherein the polymer phase includes an acrylic acid copolymer; wherein the acrylic acid copolymer includes a copolymer of acrylic acid and styrene, the acrylic acid copolymer includes maleic anhydride, or both.

12. The composite article of claim 1, wherein the polymer phase includes one or more styrene containing polymers.

13. The composite article of claim 1, wherein the composite article is a sunshade having a length of about 500 mm or more and a width of about 300 mm or more, and upon 2 cycles of heating the sunshade to 120° C. for 12 hours each and cooling the sunshade to 25° for 12 hours each, the length and width of the sunshade is within 2 mm of their initial values, and wherein the layers of the sunshade do not delaminate.

14. The composite article of claim 1, wherein the natural fibers are dyed.

15. A process for preparing the composite article of claim 1, comprising the steps of:
i) impregnating a mat with a polymer solution, wherein the mat includes one or more natural fibers and has open spaces, and the polymer solution includes one or more polymers and a sufficient amount of water so that the polymer solution can flow into the open spaces of the mat to form an impregnated mat;
ii) partially drying the impregnated mat to form a dried impregnated mat, wherein the dried impregnated mat is sufficiently dried to reduce the water concentration and/or partially cure the polymer so that the dried impregnated mat can be handled as a solid and so that the polymer does not flow out of the mat,
wherein the concentration of water in the dried impregnated mat is about 10 wt. % or more, based on the total weight of the water and the one or more polymers, so that the polymer can be cured to a higher level of cure, so that the polymer can be cured at lower temperatures, or both;
iii) curing the polymer in a mold under pressure and at a sufficiently high curing time and curing temperature so that the polymer has a glass transition temperature greater than about 100° C., and the impregnated mat becomes a reinforcing substrate,
so that a light weight composite article is formed.

16. The process of claim 15, wherein the mold is a vented mold so that water can be removed; wherein the difference in the concentration of water in the impregnated mat before molding and the concentration of water in the impregnated mat after molding is about 10 wt. % or more, wherein the concentration of water is based on the total weight of the water and the one or more polymers of the polymer solution.

17. The process of claim 16, wherein the curing temperature is about 150° C. or more, the dried impregnated mat includes about 15 weight percent or more water.

18. The process of claim 17, wherein the dried impregnated mat includes water at a concentration of about 25 weight percent or less; the polymer solution includes a curing agent; and the polymer solution is a 1 component shelf stable solution.

19. The process of claim 18, wherein the process includes a step of applying the cover stock layer having one or more class A surfaces into the mold so that the composite article has a class A surface; wherein the cover stock layer is attached to a backing layer, so that the cover stock layer is isolated from the impregnated mat; and wherein the backing layer is attached to the reinforcing substrate during the molding step.

20. A vehicle comprising a sunshade, wherein the sunshade includes a composite article according to claim 1.
